(19) United States
(12) Patent Application Publication
(10) Pub. No.: US 2015/0082768 A1
(43) Pub. Date: Mar. 26, 2015

(54) SYSTEMS AND METHODS FOR FACILITATING SUBSTANTIALLY UNIFORM VENTILATION AIRFLOW INSIDE AN ENGINE ENCLOSURE OF A GAS TURBINE ENGINE

(71) Applicant: General Electric Company, Schenectady, NY (US)

(72) Inventors: Fernando LOPEZ-PARRA, Warsaw (PL); Pawel Jan Jablecki, Warsaw (PL); Robert Allen Baten, Houston, TX (US); Balakrishnan Ponnuraj, Houston, TX (US); Pawel Barej, Warsaw (PL)

(21) Appl. No.: 14/453,919

(22) Filed: Aug. 7, 2014

(30) Foreign Application Priority Data
Sep. 24, 2013 (PL) P-405434

(51) Int. Cl. F02C 7/18

(52) U.S. Cl. CPC F02C 7/18; F05D 2220/32; F05D 2260/232; F05D 2260/2212
USPC 60/39.83

(57) ABSTRACT

A diffuser assembly for a ventilation system is disclosed herein. The diffuser assembly may include a boundary defining an interior of the diffuser assembly. The diffuser assembly also may include at least one inlet to the interior of the diffuser assembly. The at least one inlet to the interior of the diffuser assembly may be in fluid communication with at least one ventilation fan. Moreover, the diffuser assembly may include an outlet from the interior of the diffuser assembly. The outlet from the interior of the diffuser assembly may be in fluid communication with an engine enclosure. In this manner, the outlet from the interior of the diffuser assembly may be configured to provide a flow of ventilation air from the at least one ventilation fan as a substantially uniform flow of ventilation air within the engine enclosure.

### FIELD OF THE DISCLOSURE

Embodiments of the disclosure relate generally to a gas turbine engine and more particularly to systems and methods for facilitating substantially uniform ventilation airflow inside an engine enclosure of the gas turbine engine.

### BACKGROUND OF THE DISCLOSURE

Generating sufficient and efficient ventilation airflow for a gas turbine engine mounted in a confined space is often a difficult task due to the amount of mass flow required to avoid the formation and development of hotspots. Typically, a pair of ventilation fans are mounted about the gas turbine engine. The pair of ventilation fans are configured to circulate enough ambient air throughout the engine enclosure to avoid the development of hotspots. One of the ventilation fans may be a standard operation fan (or the main fan) and the other ventilation fan (or auxillary fan) may act as a backup in situations when the main fan fails or does not produce enough ventilation flow. In addition to ensuring that a similar amount of heat is removed from the engine enclosure and discharged into the ambient environment, it is also desirable that the ventilation fans are capable of delivering sufficient dilution ventilation flow in the case of a fuel gas leak within the engine enclosure. In these cases, it is desirable that each fan produces similar flow paths around the fuel manifold area of the gas turbine engine.

### BRIEF DESCRIPTION OF THE DISCLOSURE

Some or all of the above needs and/or problems may be addressed by certain embodiments of the disclosure. According to one embodiment, there is disclosed a diffuser assembly for a ventilation system. The ventilation system may include at least one ventilation fan configured to provide a flow of ventilation air to an engine enclosure positioned at least partially about a gas turbine engine. The diffuser assembly may include a boundary defining an interior of the diffuser assembly. The diffuser assembly also may include at least one inlet to the interior of the diffuser assembly. The at least one inlet to the interior of the diffuser assembly may be in fluid communication with the at least one ventilation fan. Moreover, the diffuser assembly may include an outlet from the interior of the diffuser assembly. The outlet from the interior of the diffuser assembly may be in fluid communication with the engine enclosure. In this manner, the outlet from the interior of the diffuser assembly may be configured to provide the flow of ventilation air from the at least one ventilation fan as a substantially uniform flow of ventilation air within the engine enclosure.

According to another embodiment, there is disclosed a ventilation system for a gas turbine engine. The ventilation system may include an engine enclosure disposed at least partially about the gas turbine engine. The engine enclosure may include an inlet. The ventilation system also may include at least one ventilation fan in fluid communication with the inlet of the engine enclosure. The at least one ventilation fan may be configured to provide a flow of ventilation air to the engine enclosure. Moreover, the ventilation system may include a diffuser assembly positioned downstream of the ventilation fan about the inlet of the engine enclosure. The diffuser assembly may be configured to provide the flow of ventilation air from the at least one ventilation fan as a substantially uniform flow of ventilation air within the engine enclosure.

Further, according to another embodiment, there is disclosed a method for providing a substantially uniform ventilation airflow inside an engine enclosure of a gas turbine engine. The method may include flowing a flow of ventilation air to a diffuser assembly box positioned upstream of an engine enclosure for a gas turbine engine. The method also may include diffusing the flow of ventilation air with the diffuser assembly box. Moreover, the method may include providing the flow of ventilation air from the diffuser assembly box as a substantially uniform flow of ventilation air within the engine enclosure.

Other embodiments, aspects, and features of the invention will become apparent to those skilled in the art from the following detailed description, the accompanying drawings, and the appended claims.

### BRIEF DESCRIPTION OF THE DRAWINGS

Reference will now be made to the accompanying drawings, which are not necessarily drawn to scale.

FIG. 1 schematically depicts an example top view of a gas turbine engine assembly, according to an embodiment of the disclosure.

FIG. 2 schematically depicts an example perspective view of a diffuser assembly, according to an embodiment of the disclosure.

FIG. 3 schematically depicts an example perspective view of a diffuser assembly, according to an embodiment of the disclosure.

FIG. 4 schematically depicts an example perspective view of a diffuser assembly, according to an embodiment of the disclosure.

### DETAILED DESCRIPTION OF THE DISCLOSURE

Illustrative embodiments will now be described more fully hereinafter with reference to the accompanying drawings, in which some, but not all embodiments are shown. The disclosure may be embodied in many different forms and should not be construed as limited to the embodiments set forth herein. Like numbers refer to like elements throughout.

Illustrative embodiments of the disclosure are directed to, among other things, systems and methods for facilitating substantially uniform ventilation airflow inside an engine enclosure of a gas turbine engine. For example, in certain embodiments, a diffuser assembly may be incorporated into a ventilation system for the gas turbine engine for the purpose of creating homogeneous ventilation flow inside the engine enclosure. The incorporation of the diffuser assembly into the ventilation system may reduce reversed ventilation airflow regions within the engine enclosure and substantially improve the symmetry of the ventilation airflow with respect to an axial centerline of the gas turbine engine within the engine enclosure. As a result, the ventilation system may provide the required level of engine enclosure cooling and purging regardless of which ventilation fan (e.g., a main fan and/or an auxiliary fan) is operating. In this manner, the diffuser assembly may enable the safe operation of the gas turbine engine even when the main ventilation fan fails and the auxiliary fan supplies the ventilation airflow.

In certain embodiments, the ventilation system may include at least one ventilation fan configured to provide a flow of ventilation air to an engine enclosure positioned at least partially about a gas turbine engine. For example, the ventilation system may include a main ventilation fan and/or an auxiliary ventilation fan. Additional ventilation fans may also be associated with the ventilation system. In this manner, one or more of the ventilation fans, individually or collectively, may supply the flow of ventilation air to the engine enclosure.

In some instances, the diffuser assembly may be positioned downstream of the ventilation fans and upstream of the engine enclosure. The diffuser assembly may include a boundary (such as one or more outer walls or the like) that defines an interior of the diffuser assembly. That is, the diffuser assembly may include an internal volume. For example, the diffusor assembly may include a diffuser box or the like having an inlet and an outlet. In some instances, the diffuser box may be formed of steel or other suitable material(s).

The diffuser assembly also may include at least one inlet to the interior of the diffuser assembly. The inlet to the interior of the diffuser assembly may be in fluid communication with one or more of the ventilation fans. Moreover, the diffuser assembly may include an outlet to the interior of the diffuser assembly. The outlet to the interior of the diffuser assembly may be in fluid communication with the engine enclosure. In this manner, the inlet to the interior of the diffuser assembly may be configured to receive the flow of ventilation air from the ventilation fans, and the outlet to the interior of the diffuser assembly may be configured to provide the flow of ventilation air from the ventilation fans as a substantially uniform flow of ventilation air within the engine enclosure.

In certain embodiments, the outlet to the interior of the diffuser assembly may include a number of orifices. For example, the outlet of the interior of the diffuser assembly may include a plate that forms at least one of the walls of the diffuser box. In this manner, the plate may include a number of orifices therethrough. Depending on the placement and the number of orifices, the plate may include a porosity of about fifty percent. The porosity may vary depending on engine enclosure and ventilation system design configuration. In some instances, the orifices may be angled.

The inlet to the interior of the diffuser assembly may be positioned opposite the outlet to the interior of the diffuser assembly. That is, opposing boundaries of the diffuser box may form the inlet and the outlet to the diffuser box, respectively. In this manner, the outlet to the interior of the diffuser assembly may be positioned directly opposite the inlet to the interior of the diffuser assembly. Moreover, the boundary of the diffuser assembly may at least partially extend across at least one of: a width, a length, or a height of the engine enclosure. In some instances, in order to direct the flow of ventilation air, the diffuser assembly may include at least one guide vane positioned downstream of the outlet to the interior of the diffuser assembly.

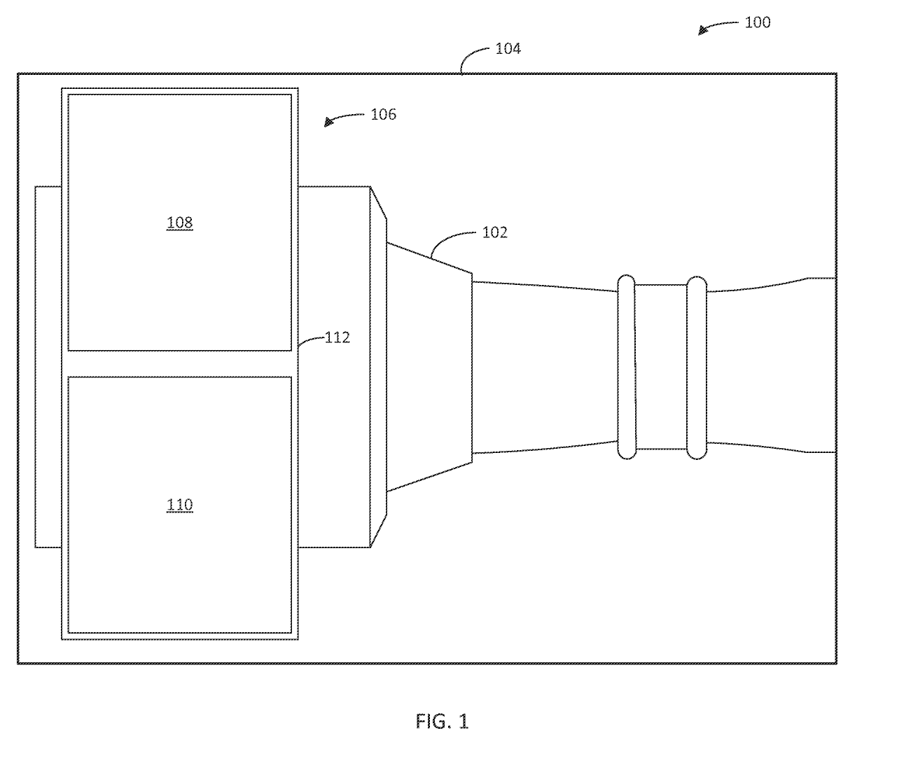

FIG. 1 schematically depicts an example top view of a gas turbine engine assembly 100, according to an embodiment of the disclosure. The gas turbine engine assembly 100 may include a gas turbine engine 102 positioned at least partially within an engine enclosure 104. The gas turbine engine assembly 100 also may include a ventilation system 106 configured to provide a flow of ventilation air to the engine enclosure 104. The flow of ventilation air may cool and/or purge the engine enclosure 104. The ventilation system 106 may include a main fan 108 and an auxiliary fan 110, although more or less fans may also be used. In certain embodiments, in order to provide a compact design, the main fan 108 and the auxiliary fan 110 may be mounted side-by-side about the engine enclosure 104 at the same axial location and symmetrically with respect to the gas turbine engine 102. The ventilation fans, however, may be located anywhere about the engine enclosure 104. In some instances, the ventilation fans may be in communication with the engine enclosure 104 by way of one or more conduits or ducts.

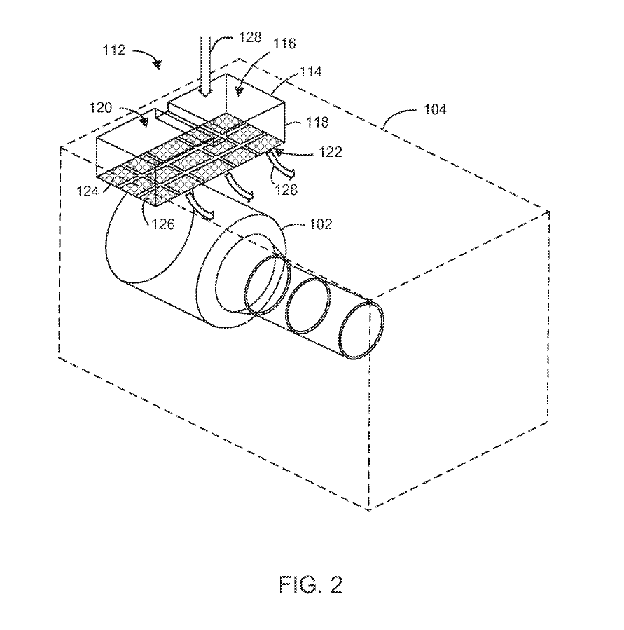

FIGS. 1-4 schematically depict an example diffuser assembly 112, according to an embodiment of the disclosure. The diffuser assembly 112 may form part of the ventilation system 106. For example, the diffuser assembly 112 may be positioned downstream of the main fan 108 and the auxiliary fan 110 and upstream of the engine enclosure 104 or at least partially within the engine enclosure 104. The diffuser assembly 112 may include a boundary 114 (such as a number of walls or the like) that defines an interior of the diffuser assembly 112. That is, the diffuser assembly 112 may include an internal volume 116. For example, the diffusor assembly 112 may include a diffuser box 118 or the like. In some instances, the diffuser box 118 may be formed of steal or other suitable material(s).

The diffuser box 118 may include at least one inlet 120 to the interior of the diffuser assembly 112. The inlet 120 to the interior of the diffuser assembly 112 may be in fluid communication with one or more of the ventilation fans. Moreover, the diffuser box 118 may include an outlet 122 from the interior of the diffuser assembly 112. The outlet 122 from the interior of the diffuser assembly 112 may be in fluid communication with the engine enclosure 104. In this manner, the inlet 120 to the interior of the diffuser assembly 112 may be configured to receive a flow of ventilation air 128 from the ventilation fans, and the outlet 122 from the interior of the diffuser assembly 112 may be configured to provide the flow of ventilation air 128 from the ventilation fans as a substantially uniform flow of ventilation air within the engine enclosure 104.

In certain embodiments, one or more walls (or plates) 124 may define at least a portion of the boundary 114 of the diffuser box 118. The plates 124 may include an array of orifices 126. For example, in some instances, at least one plate 124 of the diffusor box 118 may include an array of one inch diameter orifices 126 that form a porosity of about fifty percent. In this manner, at least a portion of the flow ventilation air 128 generated by the ventilation fans may enter the engine enclosure 104 though the orifices 126 directly below the ventilation fans. Moreover, at least a portion of the flow ventilation air 128 may impinge on the perforated plate 124 of the diffuser box 118, thereby increasing the static pressure locally within the diffuser box 118 and facilitating the flow of ventilation air 128 into the engine enclosure 104 through the remainder of the orifices 126 in the diffuser box 118. As a result, the ventilation flow 128 inside the engine enclosure 104 may become substantially more uniform with respect to the center line of the gas turbine engine 102. This provides a more consistent ventilation performance regardless of which ventilation fan is operating. In some instances, because the porosity of the perforated plate 124 may be kept relatively high, the additional pressure drop caused by the plate 124 may be easily overcome by the ventilation fans.

In certain embodiments, the diffuser box 118 may cover the entire span of the engine enclosure 104 so that both the main fan 108 and/or the auxiliary fan 110 discharges the ventilation airflow inside engine enclosure 104.

The location of the orifices 126 about the diffuser box 118 can vary depending on the ventilation flow path requirements. The location of the orifices 126 can be determined by the features of each individual gas turbine engine assembly 100 configuration. However, in some instances, the horizontal surface (i.e., the plate or wall 124) directly below the ventilation fans may be perforated in order to avoid generating excessive pressure losses due to the incorporation of the diffuser box 118 into the ventilation system 106. The location of the orifices 126, however, can be anywhere about the diffuser box 118, including the sides and/or bottom of the diffuser box 118.

The porosity of the diffuser box 118 can be determined by the size of the orifices 126 with respect to the size of the blocked area, i.e., the solid walls or plates 124 that form the boundary 114 of the diffuser box 118. In one embodiment, the orifices 126 may include a diameter of about one inch and a centre-to-centre separation of about one and a half inches. The internal volume 116 of the diffuser box 118 may be optimized in order to avoid excessive pressure drops that may diminish the performance of the ventilation system 106. That is, in certain embodiments, the diffuser box 118 may provide sufficient expansion volume in order to minimize the impact of the blockage on the ventilation fans. For example, in some instances, the volume 116 of the diffuser box 118 can expand in the direction of the flow generated by the ventilation fans. For example, in the depicted configuration, the ventilation fans blow vertically; hence, the diffuser box 118 may expand in the vertical direction by about twenty-five inches in certain embodiments.

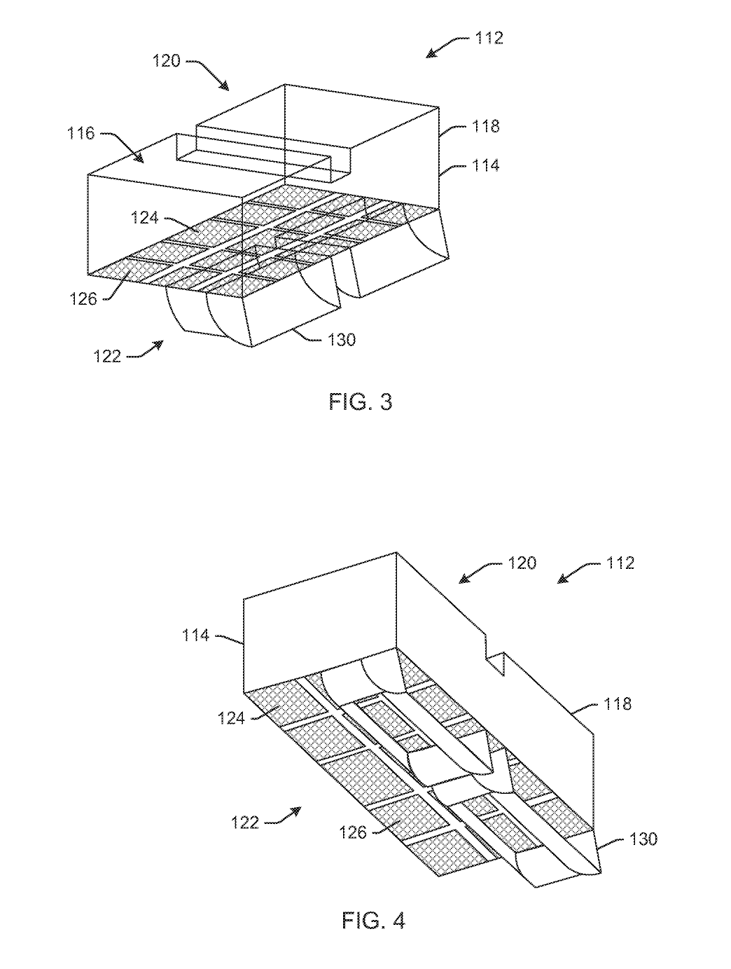

In some instances, as depicted in FIGS. 3 and 4, in order to direct the flow of ventilation air 122, the diffuser assembly 112 may include at least one guide vane 130 positioned downstream of the outlet 122 to the interior of the diffuser assembly 112. In certain embodiments, the guide vanes 130 may direct the ventilation flow 128 along the engine casing. In other instances, the side walls of the diffuser box 118 may be perforated in order to direct the flow of ventilation air 128. Moreover, the orifices 126 may be angled in order to direct the flow of ventilation air 128. Depending of the flow requirements and configuration of the engine enclosure 104, the diffuser assembly 112 can include a single-piece guide vane 130 or multiple guide vanes 130.

The diffuser assembly 112 is not limited to a strict box like shape. For example, in certain embodiments, the diffuser box 118 may include chamfered corners, non-planar sides, etc.

Although embodiments have been described in language specific to structural features and/or methodological acts, it is to be understood that the disclosure is not necessarily limited to the specific features or acts described. Rather, the specific features and acts are disclosed as illustrative forms of implementing the embodiments.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims

That which is claimed:

1. A diffuser assembly for a ventilation system, the ventilation system comprising at least one ventilation fan configured to provide a flow of ventilation air to an engine enclosure positioned at least partially about a gas turbine engine, the diffuser assembly comprising:
a boundary defining an interior of the diffuser assembly;
at least one inlet to the interior of the diffuser assembly, wherein the at least one inlet to the interior of the diffuser assembly is in fluid communication with the at least one ventilation fan; and
an outlet from the interior of the diffuser assembly comprising a plurality of orifices, wherein the outlet from the interior of the diffuser assembly is in fluid communication with the engine enclosure, and wherein the outlet from the interior of the diffuser assembly is configured to provide the flow of ventilation air from the at least one ventilation fan as a substantially uniform flow of ventilation air within the engine enclosure.

2. The diffuser assembly of claim 1, wherein the plurality of orifices comprises a plurality of angles orifices.

3. The diffuser assembly of claim 1, wherein the outlet from the interior of the diffuser assembly comprises a porosity of about fifty percent.

4. The diffuser assembly of claim 1, wherein the at least one inlet to the interior of the diffuser assembly is positioned opposite the outlet from the interior of the diffuser assembly.

5. The diffuser assembly of claim 1, wherein the boundary of the diffuser assembly extends across at least one of: a width, a length, or a height of the engine enclosure.

6. The diffuser assembly of claim 1, further comprising at least one guide vane positioned downstream of the outlet from the interior of the diffuser assembly.

7. The diffuser assembly of claim 1, wherein the at least one ventilation fan comprises a main ventilation fan and an auxiliary ventilation fan.

8. The diffuser assembly of claim 1, wherein the boundary of the diffusor comprises a box-like structure.

9. A ventilation system for a gas turbine engine, the ventilation system comprising:
an engine enclosure disposed at least partially about the gas turbine engine, the engine enclosure comprising an inlet;
at least one ventilation fan in fluid communication with the inlet of the engine enclosure, wherein the at least one ventilation fan is configured to provide a flow of ventilation air to the engine enclosure; and
a diffuser assembly positioned downstream of the ventilation fan about the inlet of the engine enclosure, wherein the diffuser assembly is configured to provide the flow of ventilation air from the at least one ventilation fan as a substantially uniform flow of ventilation air within the engine enclosure.

10. The system of claim 9, wherein the diffuser assembly comprises:
a box-like structure defining an interior of the diffuser assembly;
at least one inlet to the interior of the diffuser assembly, wherein the at least one inlet to the interior of the diffuser assembly is in fluid communication with the at least one ventilation fan; and
an outlet from the interior of the diffuser assembly, wherein the outlet from the interior of the diffuser assembly is in fluid communication with the inlet of the engine enclosure, and
wherein the outlet from the interior of the diffuser assembly is configured to provide the flow of ventilation air from the at least one ventilation fan as a substantially uniform flow of ventilation air within the engine enclosure.

11. The system of claim 10, wherein the outlet from the interior of the diffuser assembly comprises a plurality of orifices.

12. The system of claim 11, wherein the plurality of orifices comprises a plurality of angles orifices.

13. The system of claim 11, wherein the outlet from the interior of the diffuser assembly comprises a porosity that may vary depending on the ventilation requirements.

14. The system of claim 10, wherein the at least one inlet to the interior of the diffuser assembly is positioned opposite the outlet from the interior of the diffuser assembly.

15. The system of claim 10, wherein the box-like structure of the diffuser assembly extends across at least one of: a width, a length, or a height of the engine enclosure.

16. The system of claim 10, further comprising at least one guide vane positioned downstream of the outlet to the interior of the diffuser assembly.

17. The system of claim 10, wherein the at least one ventilation fan comprises a main ventilation fan and an auxiliary ventilation fan.

18. A method for providing a substantially uniform ventilation airflow inside an engine enclosure of a gas turbine engine, the method comprising:
flowing a flow of ventilation air to a diffuser assembly box positioned upstream of the engine enclosure for the gas turbine engine;
diffusing the flow of ventilation air within the diffuser assembly box; and
providing the flow of ventilation air from the diffuser assembly box as a substantially uniform flow of ventilation air within the engine enclosure.

19. The method of claim 18, further comprising guiding the substantially uniform flow of ventilation air with at least one guide vane.

20. The method of claim 18, further comprising guiding the substantially uniform flow of ventilation air with at least one orifice.
